(19) United States
(12) Patent Application Publication
(10) Pub. No.: US 2004/0088188 A1
(43) Pub. Date: May 6, 2004

(54) Method and apparatus for reconciling patient and procedure information in a medical facility computer network and imaging system

(76) Inventors: Mohamed Ali Hamadeh, Waukesha, WI (US); Stephanie A. Short, Mukwonago, WI (US); Sundar Swamy, Bangalore (IN); Anil Issac, Banaglaore (IN); Renuka Uppaluri, Pewaukee, WI (US); Lloyd W. Ison, Waukesha, WI (US); Renaud B. Maloberti, Pewaukee, WI (US); Jianqing Yao, Rochester, NY (US)

Correspondence Address: QUARLES & BRADY LLP, 411 E. WISCONSIN AVENUE, SUITE 2040, MILWAUKEE, WI, 53202-4497, US

(21) Appl. No.: 10/286,103

(22) Filed: Nov. 1, 2002

(51) Int. Cl. G06F 17/60

(52) U.S. Cl. 705/2; 715/530

(57) ABSTRACT

Disclosed is a method for reconciling mismatches in data in a hospital computer system by selectively preventing editing of data entered at a first location at a second location, and providing for re-mapping of data acquired in an incorrect data structure to a corrected data structure.

### CROSS-REFERENCE TO RELATED APPLICATION

None.

### STATEMENT REGARDING FEDERALLY SPONSORED RESEARCH OR DEVELOPMENT

None.

### BACKGROUND OF THE INVENTION

The present invention is related to the acquisition and storage of patient information and medical procedure data in a medical facility computer system, and more particularly to the reconciliation of patient and image acquisition data in a medical computer network used in conjunction with medical imaging workstations.

Computer networks employed in hospitals and particularly hospital radiology departments typically include a Hospital (or Radiology) Information System (HIS) for entering and storing patient and procedure data, an acquisition workstation for controlling image acquisition equipment, and a Picture Archival and Communication System (PACS) for archiving the acquired image data along with other information such as billing data. In use, patient data and required imaging procedures are entered into the HIS system and downloaded or otherwise transmitted to the acquisition workstation. Alternatively, or in addition to the entries at the HIS, the patient data can be entered directly into or edited at the workstation. After the data is entered images are acquired at the workstation, and the acquired data is transmitted to the PACS for archiving and storage.

As noted above, in medical computer networks of this type, patient data and required procedures can typically be entered manually or edited by the users at both the HIS and acquisition workstation terminals. The ability to enter and edit data is advantageous in that it allows flexibility in the workflow at the medical facility. However, multiple data entry points can also lead to mismatches between the data stored at the various nodes of the network. For example, a patient name entered at the HIS system may vary in spelling from the patient name entered at the workstation, making it difficult to retrieve the appropriate patient test results. Furthermore, image data of one anatomical view, for example a hip, can be acquired at the workstation and filed incorrectly under a data structure for a chest or other anatomical view entered at the HIS system. When problems like this occur it can be difficult to correlate the view with the correct data. Not infrequently, such errors lead to time-consuming repetitive tasks, such as the need to acquire a second set of images for the patient, the need to correct under and over billings, and other administrative and medical tasks.

### SUMMARY OF THE INVENTION

In one aspect, the present invention is an acquisition workstation for use in controlling medical imaging equipment in a hospital computer network, where the hospital computer network includes both a hospital information system (HIS) and the workstation, each of which is capable of receiving patient data. The workstation generally comprises a processor, a memory component coupled to the processor, a user input device, a network interface for coupling the workstation to the hospital computer network, and the memory component including a database of patient data structures including patient identifiers and an interface for transmitting control signals from the processor to the medical imaging equipment and for receiving imaging data from the medical imaging equipment.

Data including patient identification information and imaging procedures are provided in a data structure either at the workstation or at the HIS system. Each of the patient data structures is associated with an indicator indicating whether the patient data structure originated at the HIS or the workstation, and entry of data at the workstation is selectively disallowed when the patient data structure originated at the hospital information system.

In another aspect of the invention, the user input device can be used to provide a local patient data structure that can be entered at and edited at the workstation.

In another aspect of the invention, a method for reconciling data in a hospital network including a diagnostic medical image acquisition workstation and a hospital information system (HIS) is provided. The method comprises the steps of linking the medical image acquisition workstation to the hospital information system (HIS), entering and storing patient and procedure data in a patient data structure in the hospital information system, associating an indicator with the patient data structure indicating that the data was entered at the HIS, selectively transmitting the patient data structure to the workstation, checking the indicator status at the workstation; and disabling editing of the patient data structure at the workstation if the indicator is on.

These and other aspects of the invention will become apparent from the following description. In the description, reference is made to the accompanying drawings which form a part hereof, and in which there is shown a preferred embodiment of the invention. Such embodiment does not necessarily represent the full scope of the invention and reference is made therefore, to the claims herein for interpreting the scope of the invention.

### BRIEF DESCRIPTION OF THE DRAWINGS

FIG. 1 is a block diagram of a hospital computer network.

FIG. 2 is a block diagram of a workstation for use in the hospital computer network of FIG. 1.

FIG. 3 is a block diagram of a patient data structure.

FIG. 4 is a workflow diagram for acquiring images at the workstation of FIG. 1 when editing at the workstation is disabled.

FIG. 5 is a workflow diagram of an editing procedure for editing local data at the workstation of FIG. 1.

### DETAILED DESCRIPTION OF THE PREFERRED EMBODIMENT

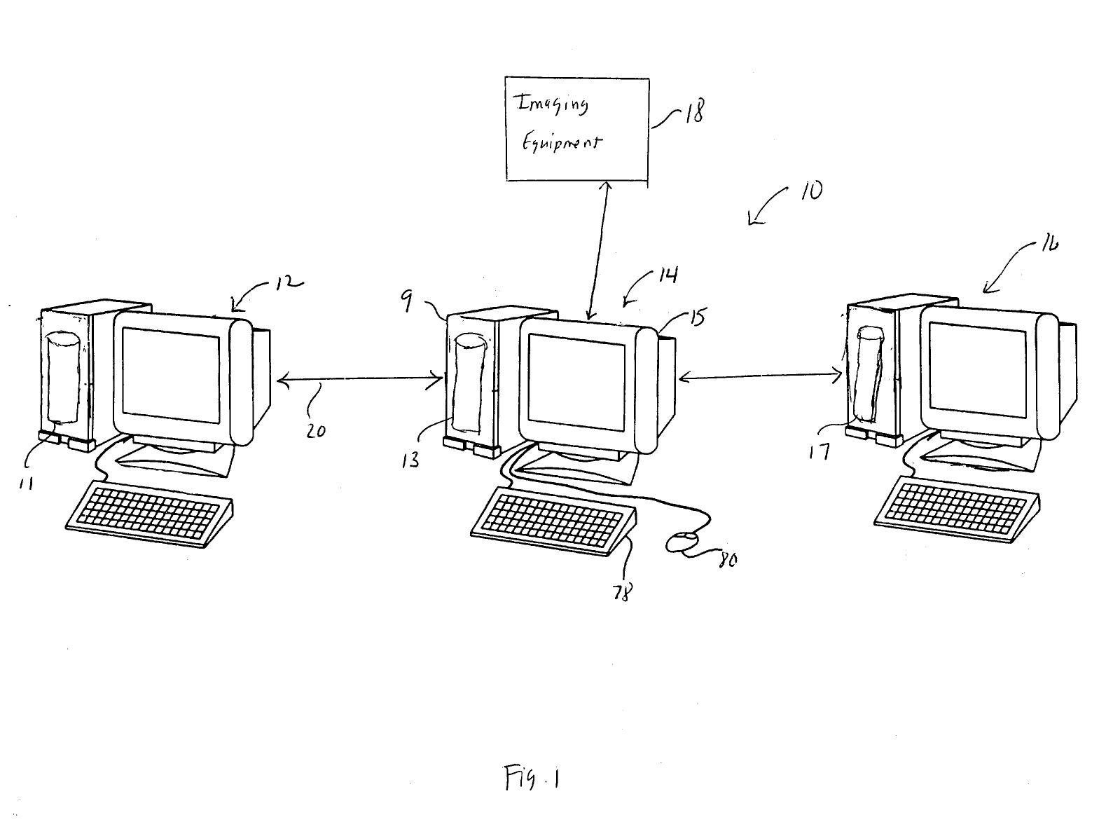

Referring now to the Figures and more particularly to FIG. 1, a hospital computer network 10 is shown. The computer network 10 includes a hospital or radiology information system (HIS) 12 including a database stored in memory 11, an image acquisition workstation 14 linked to imaging equipment 18 and including a database stored in memory 13, and a picture archive and communications system (PACS) 16 for archiving acquired images and associated data in memory 17. The HIS 12, acquisition workstation 14, and PACS 16 are linked via a communications network 20 which can be, for example, an intranet link, hard wired network, wireless network, or other types of communications links well know to those of skill in the art.

In operation, the HIS 12 is typically located at a front desk, and is operated by an administrator who is responsible for entering patient data. The acquisition workstation 14 is typically provided in an examination room or area, and, as noted above, is coupled to medical imaging equipment 18 to provide imaging commands to the medical imaging equipment and to acquire and reconstruct image data. Upon close of an examination, acquired data is transmitted to the PACS 16 for storage. To prevent data mismatches between the HIS 12 and the acquisition workstation 14, the acquisition workstation 14 includes one or more software switches which are activated to selectively enable or disable editing capabilities at the workstation. For example, when data is entered into the HIS 12, data entry and editing at the workstation 14 can be disabled, thereby requiring all additional data entry and editing of the procedure to occur at the HIS 12. In this situation, an editing tool is provided at the workstation 14 allowing the user to manipulate and re-map acquired data as described below. Alternatively, or in addition, “local” data entry can be provided at the workstation 14, wherein data entry and editing are confined to the workstation 14. Here, a data entry screen can be provided at the workstation 14, such that local data can be entered and maintained at the workstation 14. Both flexibility and data integrity can be maintained by allowing editing of data entered at the HIS 12 only at the HIS 12 and editing of data entered at the workstation acquisition 14 only at the acquisition workstation 14, as described more fully below.

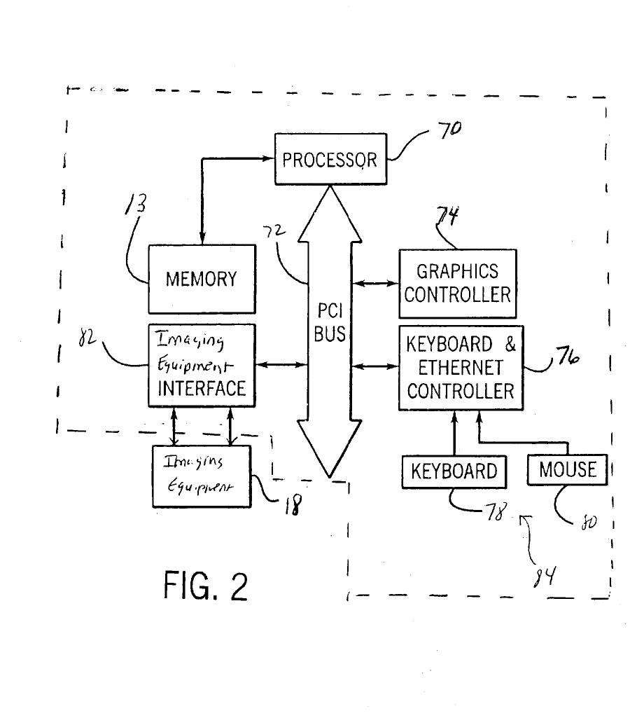

Referring now to FIGS. 1 and 2 the workstation 14 includes a case 9 which houses the processor 70 and associated circuitry, memory 13, and peripheral interface circuits including a commercially available CRT monitor or display 15, and a user input device 84 which can include, as shown, both a keyboard 78 and mouse 80. The workstation 14 includes an imaging equipment interface 82 which is connected to imaging equipment 18 both to control the imaging equipment 18 and to receive digitized image data directly from the medical imaging equipment 18. The imaging equipment can be, for example, an x-ray system, x-ray CT system, MRI system, PET scanner system or nuclear medicine system. The workstation 14 typically contains application programs which perform image processing functions, such as, filtering the medical image data, transforming the size and orientation of the medical images and adding textual information to the medical images.

Referring particularly to FIG. 2, the workstation 14 includes a processor 70 which executes instructions stored in a memory 13. The processor 70 can be, for example, a commercially available RISC processor which includes an integral PCI bus driver to provide a direct interface with a PCI bus 72 and integral memory management circuitry for handling all external memory 13 such as are available from Sun Microsystems, Inc. Other types of processors and related hardware systems will be apparent to those of ordinary skill in the art.

The PCI bus 72 is an industry standard bus that transfers data between the processor 70 and a number of peripheral controller cards. These include a network controller 76 which supports data transfer with peripheral devices, including input from the keyboard 78 and mouse 80 and an imaging equipment interface 18 which communication with network ports on medical imaging equipment 18. The workstation 14 further includes a graphics controller 74 coupled to the PCI bus 72 and to the display or monitor 15 through a connection such as a standard VGA connection (not shown). As noted above, the workstation 14 application software stored in the memory 13 includes one or more software switch for selectively disabling data manipulation or editing at the workstation 14 when data is originally input into the HIS 12, and for providing for “local” data entry and editing sets a local or trauma interface. The application software further includes a patient editing tool for allowing the user to re-map image acquisition data as described below.

Referring particularly to FIG. 2, medical images are input to the workstation 14 through a network link such as an Ethernet link associated with the imaging equipment interface 82. The image data is downloaded to the workstation through the imaging equipment interface 82 and stored in memory 13, where a number of image processing functions known to those of skill in the art may be performed on the image data.

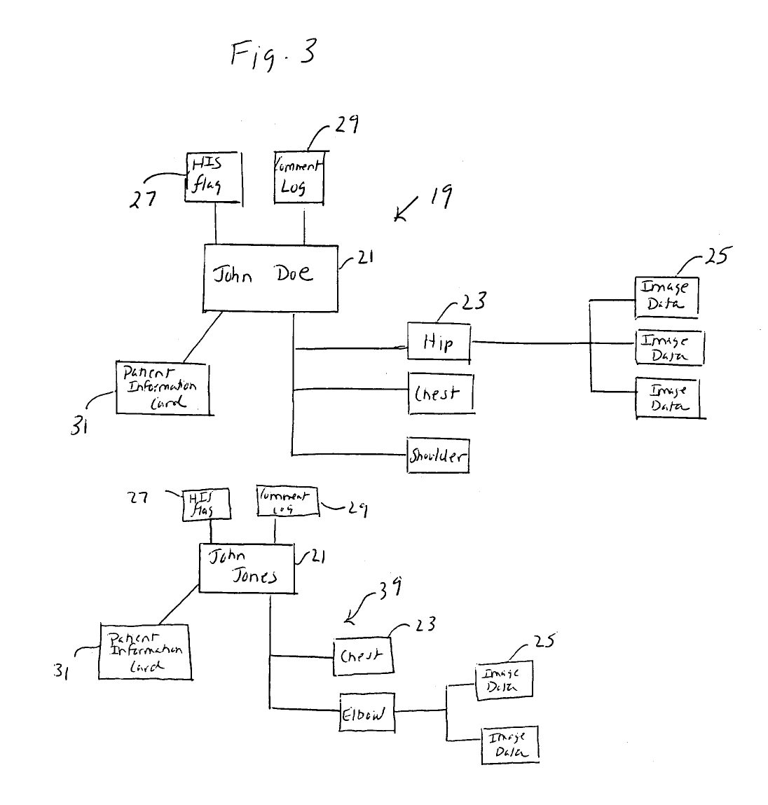

Referring now to FIG. 3, the acquired image data is preferably stored in a patient data structure 19 in the memory 13 of the workstation 14. In one embodiment, the patient data structure 19 comprises a hierarchical structure or “folder”, in which the highest level is a patient identifier 21. The patient identifier 21 typically comprises a patient name, although a social security number, phone number, accession number, or other identifying data could also be used. This data is entered into a patient information card 31 shown on the monitor 15. Beneath the top level, data related to the identified patient, including imaging or other medical procedures 23 to be performed on the subject is stored. As the results of medical procedures 23 performed on the patient are acquired, this acquisition data 25 is also stored in the patient data structure 19, typically at a level beneath the procedure. Also associated with the patient data structure 19 is a flag 27, which is set when the patient data structure 19 has been entered at the HIS 12, to allow the workstation 14 to differentiate between data entered locally and data entered at the HIS 12. The patient data structure 19 also includes a log 29 where comments related to changes in the structure can be provided, as described below. While the data structure 19 illustrates one method of organizing data, it will be apparent that there are many alternate ways of organizing patient data. Furthermore, while the patient data structure 19 is described with reference to the workstation 14, a similar patient data structure 19 is preferably provided at each of the HIS 12, workstation 14, and PCS 16 to maintain data integrity across the hospital computer network 10.

As noted above, data for the patient data structure 19 can be provided at the HIS 12 and transmitted to the image acquisition workstation 14 through the communication network 20, or entered directly as “local” data at the workstation 14. When the data is entered at the HIS 12, the flag 27 is set, thereby notifying the workstation 14 that data manipulation or entry is disabled. At the workstation 14, the patient data 19 is provided on a display screen or as a “patient information card” including patient identifiers and other data, and also including a “worklist” of medical procedures requiring image acquisition. After images are acquired, image data 25 is stored in the patient data structure 19, typically at a level beneath the procedure 23 itself. The patient data structure 19 including the images are then transmitted to the PACS 16, where they are stored, and preferably archived, typically along with billing and other data related to patient care and services. When data is entered initially at the HIS 12, editing at the workstation is preferably disabled, as described below.

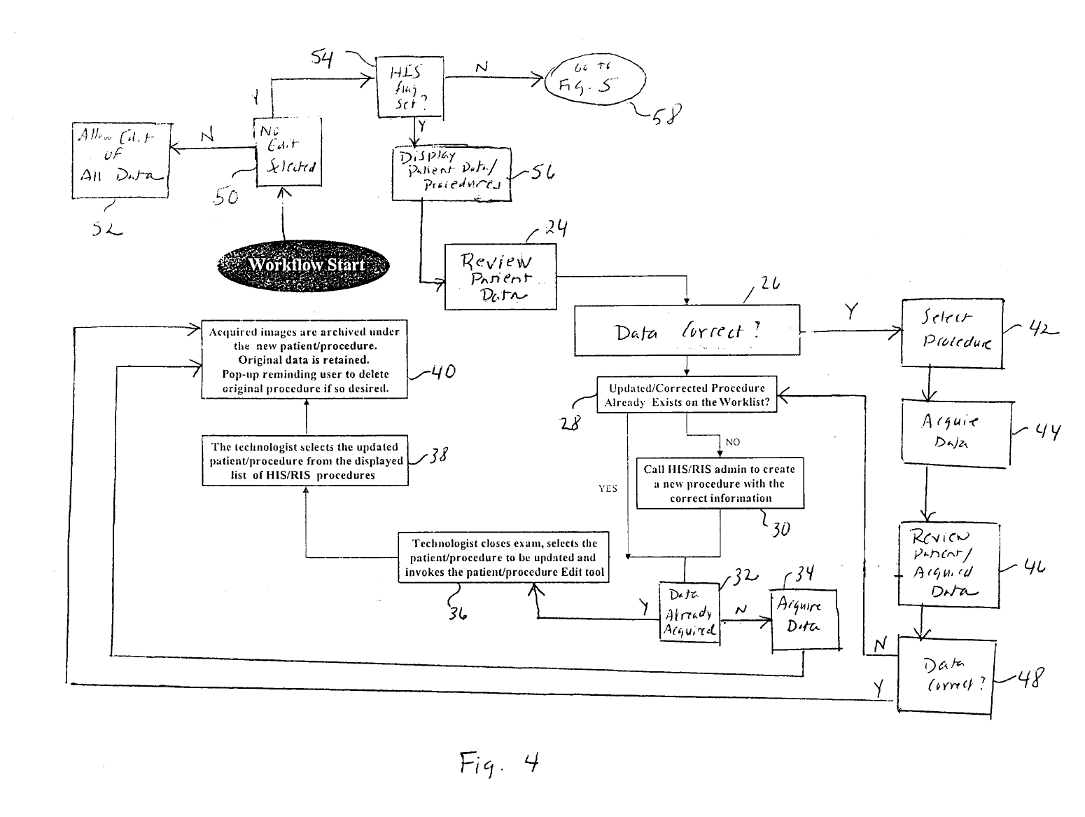

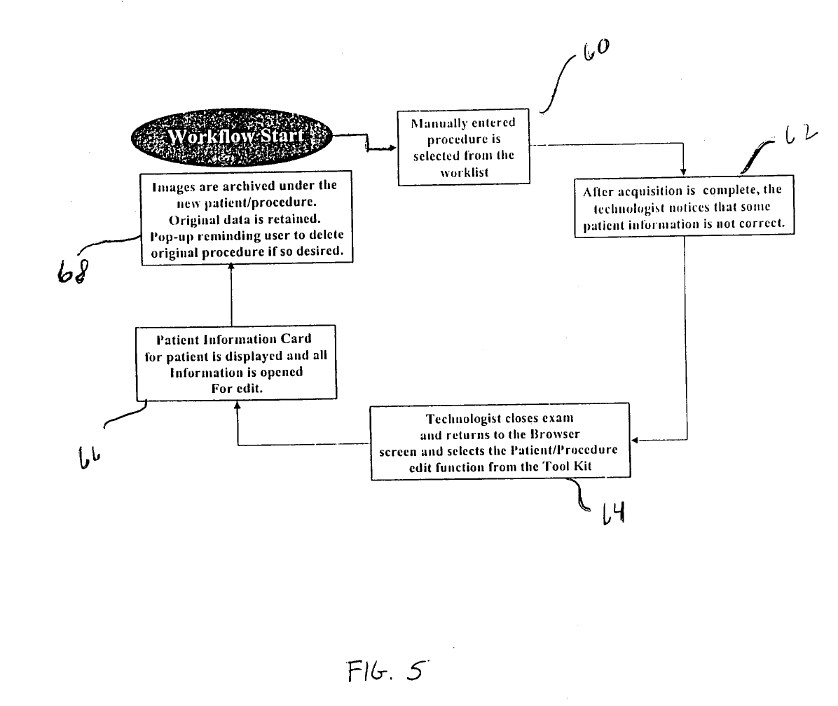

Referring now to FIGS. 4 and 5, a workflow for editing data in the patient data structure 19 is shown for each of the two situations described above. In FIG. 3, data entry is provided at the HIS 12, and editing capabilities at the workstation 14 are disabled, such that changes to the patient data structure 19 must be provided from the HIS 12. In FIG. 4, editing of the patient data structure at the workstation 14 is enabled, allowing for entry and editing of “local” patient data. Depending on the preference of the hospital, medical clinic, or radiology department in which the system is used, various combinations of editing capabilities at the HIS 12 and workstation 14 can be provided by selectively activating the editing capabilities, either permanently, on a time schedule (i.e. allowing entry of local data into the workstation 14 only when the HIS 12 is closed), or on a case-by-case basis. The case by case basis may include, for example, a “trauma” situation, in which it is desirable to proceed immediately to medical processes and therefore to the acquisition workstation 14 without first entering data at the HIS 12, as described above.

Referring now specifically to FIG. 4, the workflow procedure for a process in which the patient data structure 19 originated at the HIS 12 and editing at the workstation 14 is disabled is shown. Here, the integrity of data is maintained by requiring data entry to be performed at a single location, the HIS 12. Initially, in step 50, the workstation 14 does an internal check to determine whether software switches for disabling editing of HIS data at the workstation 14 has been set. If not, editing of all data at the workstation 14 is allowed (step 52). If the software switch is set, a second check, step 54, is made to determine whether the HIS flag 27 has been set for the selected patient data structure. If not, the data is local, and the procedure of FIG. 5 is followed (step 58), as described below. If the HIS flag 27 is set, in step 56, patient data is displayed in an uneditable form. In step 24, the technician operating the workstation 14 reviews the patient data and associated worklist of procedures at the display 15 of the workstation 14. At step 26, the technician makes a determination regarding whether the data is correct. If the data is not correct, and corrections are required, the technician can verify whether an updated or corrected procedure already exists on the workstation 14 (step 28) by looking in a database in the workstation memory 13 (FIGS. 1 and 2) for an updated procedure. If an updated or corrected procedure 28 does not exist, in step 30, the technician calls an administrator with access to create a procedure in the HIS 12, and requests a revised a corrected procedure (step 30). The administrator creates a revised procedure, and provides comments in the log 29 provided in the patient data structure 19 indicating what was done to the patient data structure 19 and why. The revised patient data structure 39 can then be transmitted to the workstation 14 and displayed on the display 15.

After the corrections are made, the technician selects the new or corrected patient data structure 39 and determines whether all images have already been acquired or whether additional images need to be acquired (Step 32). If images are to be acquired, the technician proceeds to acquire data (step 34), typically in a sequential procedure-by-procedure basis defined by the worklist on the display 15. As these images are stored in a corrected or revised data structure 39, upon completion of the acquisition steps, the technician can archive data (step 40).

If data has already been acquired, in step 36, the technician selects a patient/procedure edit tool which allows the technician to move data from the old incorrect patient data structure 19 to the corrected or revised patient data structure 39, thereby correcting errors prior to archiving (step 38). The patient/procedure edit tool allows the technician to manually map any pre-existing data from the old patient data structure 19 to the new patient data structure 39, wherein in step 40, all image data acquired in the process is archived under the corrected patient data structure. Thus, for example, if the old procedure includes a “hip” procedure and data was acquired instead for a chest, the chest images can be manually moved by the technician to a “chest” procedure listed in the corrected patient data structure using, for example, by selecting the dot portal data structure 19 and the new patient data structure 39 and selecting a correct button, through the use of drag and drop icons, or other methods known to those of skill in the art. If corrected patient data structures 39 exists, a “pop up” window can be displayed, alerting the technician to delete the old patient data structure 19, if desired or necessary.

Referring again to step 26, if the initial data in the patient data structure 19 is correct, the technician proceeds to select a procedure from the worklist (step 42) and acquire data (step 44). In step 46, the technician reviews the patient data and acquired data to again determine whether any corrections are required. If so, the workflow returns to step 38, as described above, which provides a procedure for mapping of any data acquired under the old patient data structure to a new patient data structure. If not, no corrections are required and the technician can proceed to step 40, archiving the data with the existing patient data structure 19.

Referring now to FIG. 5, the workflow for editing local data is shown. As noted above, locally-managed data can be particularly desirable in a “trauma” situation wherein it is desirable to proceed directly to patient care rather than obtain patient data as an initial step. In step 54 (FIG. 4), a check was made to verify that the data was not entered at the HIS 12. If not, the technician can review a list of local or manually entered procedures (step 60), and select a procedure to be performed from the list, or provide a new entry into a “patient information card” and then proceed to data acquisition. If after images are acquired, in step 62, the technician becomes aware that errors exist in the patient data structure 19, the technician can select an edit function (step 64), which opens the patient information card for editing (step 66). In step 68, the images are archived under the corrected patient data structure 39. Again, a pop-up window is displayed to remind the user to delete the original patient data structure, if desired or necessary. In this application, the user can directly change the patient data structure any time prior to acquisition of data, without the need for creating a new patient data structure. Locally-entered data which is stored on the workstation 14 can also be correlated or mapped to a patient data structure 19 entered through the HIS 12 prior to archiving of the data at the PACS 16, thereby preventing the need to correct data at the PACS 16. This process would require transmittal of a patient data structure 19 from the HIS 12 and process steps as described with respect to FIG. 3, above.

By providing a workflow as described above, the present invention allows for re-mapping of patient data to correlate the appropriate patient identifiers, insurance information, and image acquisition data, thereby preventing mismatches of data prior to storage in the PACS system 16. This is accomplished by preventing editing of data that originated at the HIS 12 at the workstation, as shown in FIG. 4. Data originating locally at the workstation 14, however, can be edited as shown in FIG. 5. By preventing data entry errors, the system can prevent data mismatch errors which, if not accounted for, can lead to diagnostic and billing problems, loss of medical data requiring the need to repeat data acquisition procedures, and other errors which are time consuming and lead to inefficiencies in the system.

In particular, the workflow described above is helpful in minimizing a number of common problems. For example, if patient data was entered incorrectly at either the workstation 14 or the HIS 12 and images were acquired at the workstation 14, the images can be remapped to a corrected patient data structure 39, thereby preventing problems with billing, diagnostic review, or insurance carriers. Furthermore, if images were acquired under the wrong procedure thereby mismatching the actual and expected anatomical views, image data can be remapped to a correct procedure. Furthermore, the workflow provides for a “trauma” situation in which it is necessary to enter “dummy” patient data before actual patient identifying information is acquired. The “dummy” data can also be mapped to a complete patient data structure prior to archive at the PACS 16, following procedures as described above.

The workflow described above can also be helpful in maintaining data integrity by limiting data entry to the HIS 12, and preventing manual updates at the workstation 14. Because data is entered at only one place, no mismatch in data can occur between the HIS 12 and the workstation 14.

As noted above, although a specific hospital computer system 10 has been described, the principles of the workflow as described above can be applied to any number of multiple computer systems. Furthermore, the imaging equipment 18 can provide any number of imaging modalities including x-ray, MRT, PET, ultrasound, or other imaging processes.

It should be understood that the methods and apparatuses described above are only exemplary and do not limit the scope of the invention, and that various modifications could be made by those skilled in the art that would fall under the scope of the invention. To apprise the public of the scope of this invention, the following claims are made:

1. A method for reconciling data in a hospital network including a diagnostic medical image acquisition workstation, the method comprising the following steps:
linking the medical image acquisition workstation to a hospital information system (HIS);
entering and storing patient and procedure data in a patient data structure in the hospital information system;
associating an indicator with the patient data structure indicating that the data was entered at the HIS;
selectively transmitting the patient data structure to the workstation;
checking the indicator status at the workstation; and
disabling editing of the patient data structure at the workstation if the indicator is on.

2. The method as defined in claim 1, further comprising the steps of:
reviewing the patient data structure for errors, corrections, or additional requirements at the workstation;
requesting that the patient data be revised at the HIS;
entering the revised data at the HIS and transmitting a revised patient data structure to the workstation; and
providing a patient editing tool for remapping data from the patient data structure to the revised patient data structure.

3. The method as defined in claim 1, further comprising the step of providing a message at the workstation reminding the user to delete the patient data structure after the revised patient data structure is provided.

4. The method as defined in claim 1, further comprising the steps of:
acquiring image data before obtaining a revised patient data structure; and
remapping the image data from the patient data structure 10 with the revised patient data structure.

5. The method as defined in claim 1, further comprising the step of:
transmitting the revised patient data structure to a picture archive and communications system.

6. The method as defined in claim 1, further comprising the step of associating a log of revisions with each patient data structure.

7. The method as defined in claim 1, further comprising the step of allowing data editing of the patient data structure at the workstation when the indicator is not on.

8. A method for improving integrity of patient data in a hospital medical system comprising both a hospital information system (HIS) and an image acquisition workstation, the method comprising the following steps:
providing a first data entry point at the HIS, the HIS receiving patient data including a patient identifier and a medical procedure to be performed and storing the patient identifier and the medical procedure in a patient data structure;
selectively preventing the editing of the patient data structure at the imaging workstation, wherein required changes are communicated to the HIS from the workstation, and changes are made at the workstation to provide a revised patient data structure;
transmitting the revised patient data structure from the HIS to the workstation; and
providing an editing tool allowing a user at the workstation to remap acquired image data from the patient data structure to the revised patient data structure created on the HIS.

9. The method as defined in claim 8, further comprising the step of allowing entry of a local patient data structure and editing of the local patient data structure at the workstation.

10. The method as defined in claim 8 further comprising the steps of associating an indicator with the patient data structure the indicator identifying the mode that the patient data structure was entered into.

11. The method as defined in claim 8, further comprising a log associated with the patient data structure, the log providing a location for storing data related to when the patient data structure was modified and why.

12. The method as defined in claim 8, further comprising the step of providing a software switch for selectively activating editing at the workstation.

13. An acquisition workstation for use in controlling medical imaging equipment in a hospital computer network including a hospital information system, the workstation comprising:
a processor;
a memory component coupled to the processor, the memory component including a database of patient data structures including patient identifiers and imaging procedures;
a user input device for providing data entry to and providing editing of the patient data structures;
a network interface for transmitting and receiving patient data structures from the hospital information system;
an interface for transmitting control signals from the processor to the medical imaging equipment and for receiving imaging data from the medical imaging equipment and transmitting the imaging data to the memory;
wherein each of the patient data structures is associated with an indicator indicating whether the patient data structure originated at the hospital information system or the workstation, and entry of data at the workstation is disallowed when the patient data structure originated at the hospital information system.

14. The acquisition workstation as defined in claim 13, wherein the user input device provides a local patient data structure that is provided into and edited at the workstation.

15. The acquisition workstation as defined in claim 13, wherein editing of a patient data structure at the workstation is selectively active through the user input device by activating a software switch at the acquisition workstation.
